(19) United States
(12) Patent Application Publication
(10) Pub. No.: US 2007/0265408 A1
(43) Pub. Date: Nov. 15, 2007

(54) Non-synthetic low-protein rubber latex product and method of testing

(75) Inventors: Katrina Cornish, Carlsbad, CA (US); Jali Williams, Phoenix, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: Yulex Corporation

(21) Appl. No.: 11/433,206

(22) Filed: May 11, 2006

(51) Int. Cl. C08G 83/00

(52) U.S. Cl. 528/1

(57) ABSTRACT

The present invention discloses a non-Hevea, non-synthetic, low-allergenic, low-protein latex product that conforms to the standards published by the American Society for Testing Materials for Hevea latex products, and a new method and standard for determining the qualitative and quantitative properties of such products, including the substitutability of and superiority to Hevea and synthetic latex products.

### FIELD OF THE INVENTION

The invention described herein relates to a natural latex product derived from plant materials. More specifically, the invention relates to a non-Hevea, non-synthetic, low-protein low-allergenicity latex product made from desert plants native to the southwestern United States and Mexico, including the guayule plant (Parthenium argentatum), and method of testing the properties of such products to determine quantitative and qualitative substitution for and superiority to Hevea and synthetic latex products for use in medical devices, in industrial uses and for consumer products.

### BACKGROUND OF THE INVENTION

Natural rubber, derived from the plant Hevea brasiliensis, is a core component of many industrial products such as in coatings, films, and packaging. Natural rubber is also used widely in medical devices and consumer items. More specifically, latex is used in medical products including: gloves, catheters, laboratory testing equipment, assays, disposable kits, drug containers, syringes, valves, seals, ports, plungers, forceps, droppers, stoppers, bandages, dressings, examination sheets, wrappings, coverings, tips, shields, and sheaths for endo-devices, solution bags, balloons, thermometers, spatulas, tubing, binding agents, transfusion and storage systems, needle covers, tourniquets, tapes, masks, stethoscopes, medical adhesive, and latex wound-care products.

Post-procedure patient uses for natural rubber include: compression bands, ties, and straps, inflation systems, braces, splints, cervical collars, and other support devices, belts, clothing, and the padding on wheelchairs and crutches. Natural latex is also used in many other common household products such as pacifiers, rubber bands, adhesives, condoms, disposable diapers, art supplies, toys, baby bottles, chewing gum, and electronic equipment, to name just a few.

However, the widespread use of natural rubber is problematic for several reasons. First, the vast majority of Hevea-derived natural rubber is grown from a limited number of cultivars in Indonesia, Malaysia and Thailand, using labor-intensive harvesting practices. The rubber and products made from Hevea are expensive to import to other parts of the world, including the United States, and supply chains can limit availability of materials. Furthermore, because of the restricted growing area and genetic similarity of these crops, plant blight, disease, or natural disaster has the potential to wipe out the bulk of the world's production in a short time.

Second, particularly in the medical and patient care areas, an estimated 20 million Americans have allergies to proteins found in the Southeast Asian Hevea-derived natural rubber crop. Like many other plants, Hevea produces proteins for structural support and for defense-related purposes in response to environmental conditions. However, there are at least 62 known Hevea antigens involved in Type I latex allergy, and more than a dozen of these Hevea-derived latex proteins are common human allergens, including: Hev b1, and Hev b3 used in rubber biosynthesis, defense related proteins Hev b2, Hev b4, Hev b6.01, Hev b6.02, Hev b6.03, Hev b7.01, Hev b7.02, Hev b11, and Hev b12, and other proteins such as Hev b5, Hev b8, Hev b9, and Hev b10.

An allergic response to Hevea begins when a latex-allergic individual is exposed to these proteins, triggering immunoglobulin E (“IgE”) antibody production. The IgE antibodies cause a variety of responses, depending on the severity of the allergy. Typically, latex allergies are limited to skin inflammation, but serious reactions, and even death, may occur in some individuals. Additionally, the structures of these proteins have also been evolutionarily conserved in many plants, not just Hevea, making Hevea-allergic individuals susceptible to similar proteins in other plants (“cross-reactivity”). It is also likely that human cultivation of Hevea has inadvertently selected for the presence of allergenic proteins that function as common epitopes (antigenic sites on the protein) for immunoglobulin E antibody production in latex-allergic individuals, making the effective removal of such proteins extremely difficult.

Generally, the potential allergenicity of a latex product is determined by measuring known IgE antigenic proteins, overall protein levels, and determining cross-reactivity in the particular plant species to known IgE antigenic proteins. Products with lower amounts of known IgE antigenic proteins are less likely to trigger immunoglobulin E antibody production in a latex-allergic person. Therefore, products with low numbers and levels of known IgE antigenic proteins have substantially decreased allergenicity.

Further, the more proteins present in a latex, the greater the probability that humans exposed to one or more of these proteins will become sensitized, thus developing an allergy to it. Thus, reducing protein content in latex products, especially proteins that are common human allergens, is the first step in reducing the overall number of subsequent allergic reactions.

Specific protein sensitivity varies among latex-allergic individuals, and therefore, to decrease the overall risk of allergic reaction, lower overall protein levels are desirable. Products with low levels of proteins overall are less likely to cause an allergic response and are thus substantially less allergenic than products with higher protein levels. Hevea latex products are made from latex that typically contains more than 9,000 μg total protein per gram dry weight latex, including the antigenic proteins mentioned above; and the higher the total protein per gram dry weight, the more likely the allergic reaction.

There are also a number of non-Hevea plants that are known to be cross-reactive with Hevea-allergic individuals. These plants contain similar types of structural support and defense-related plant proteins and may produce similar allergic responses in humans. These types of plants are far less likely sources for a low-allergenic natural rubber alternative to Hevea.

Overall, the widespread pervasiveness of latex allergies in the U.S. population is costly, particularly in the medical area. To avoid unnecessary allergic reactions during medical procedures, providers must ensure that only alternative latex products come into contact with a latex-allergic patient. Furthermore, practitioners who themselves have latex allergies must ensure that they do not come into contact with natural latex-based products. Finally, synthetic rubber alternatives are often much more expensive or are unavailable in non-Hevea latex forms. Therefore, a need exists for non-synthetic low-protein natural rubber latex products that are qualitatively and quantitatively suitable for substitution of or are superior to existing Hevea or synthetic latex products.

Generally, extracted latex for industrial or medical uses is tested for conformity with the standard specifications of various regulatory bodies, including the American Society for Testing Materials (“ASTM”). Each type of latex product is given an ASTM “type.” For example, Type I includes centrifuged Hevea latex preserved with ammonia only or by formaldehyde. Type II latex is Hevea latex that has been creamed and preserved with ammonia only or by formaldehyde followed by ammonia and Type III latex is centrifuged Hevea latex preserved with low ammonia or other preservatives. Type I, II, and III latex products are tested according to the respective I, II, or III ASTM D1076-02 Standards. See Table 1.

TABLE 1

| | ASTM D1076-02 Property Standards | | |
|---|---|---|---|
| | TYPE I | TYPE II | TYPE III |
| | Latex | Latex | Latex |
| | Product | Product | Product |
| Color and Odor | None | None | None |
| | Pronounced | Pronounced | Pronounced |
| Total Solids | 63.1 | 66.0 | 61.3 |
| Content (min %) | | | |
| Dry Rubber | 59.8 | 64.0 | 59.8 |
| Content (min %) | | | |
| Total Solids | 2.0 | 2.0 | 2.0 |
| Content minus Dry | | | |
| Rubber Content | | | |
| (max %) | | | |
| Total Alkalinity | 0.60 min | 0.55 min | 0.29 max |
| (ammonia as % of | | | |
| latex) | | | |
| Mechanical | 650 | 650 | 650 |
| Stability @ | | | |
| 55% TSC, seconds | | | |
| Copper (max % of | 0.0008 | 0.0008 | 0.0008 |
| total solids) | | | |
| Manganese (max % of | 0.0008 | 0.0008 | 0.0008 |
| total solids) | | | |
| Sludge Content, Max % | 0.10 | 0.10 | 0.10 |
| Coagulum Content, Max % | 0.050 | 0.050 | 0.050 |
| KOH Number, Max | 0.80 | 0.80 | 0.80 |

The ASTM D1076-02 Standard provides a standards table, listing a number of physical or chemical properties, for Types I, II and III latex products as shown in Table 1. Each of these properties is associated with a standard numeric or standard written value to indicate the standard minimum or maximum amount allowed for a latex product to conform to the requirements for that type. Standard written values provide a method of quantification where measurement by standard numeric value is difficult or impossible (e.g., the words ‘absent’ or ‘present’ are written values). Each of the properties is measured according to standard methods, as required in the ASTM D1076-02 Standard and given a detected numeric value, or a detected written value, based on experimental results. These detected written values or detected numeric values are then compared with the standard numeric value and standard written value for each property. After all properties are assayed, compliance with the ASTM D1076-02 Standard can be determined; and if all the properties meet the standard written or standard numeric values, the latex will be in compliance with the ASTM D1076-02 Standard.

However, even synthetic or Hevea latex products that can conform to these standards have recalcitrant problems when used in medical products and in the medical device industry. As discussed in detail above, Hevea latex causes sensitization and allergic reactions. In many of these end-use applications, further substitution of Hevea latex with synthetic polymers is an inadequate solution because these synthetic polymers often fail to perform as needed.

Thus the ASTM D1076-02 Standard is insufficient in determining the physical or chemical properties of non-Hevea natural latex, because it is only directed toward Hevea latex. Therefore, a need also exists for a method and standard of determining the chemical or physical properties of a higher-quality, low-protein, low-allergenic, non-crossreactive, domestic natural rubber source, that could be used to quantitatively and qualitatively assess the substitutability and superiority of a non-Hevea natural rubber latex alternative for use in medical, industrial, and consumer products and applications.

### BRIEF DESCRIPTION OF THE DRAWINGS

FIG. 1 is an immunoblot picture comparing Hevea latex and non-Hevea latex proteins.

FIG. 2 is a graph depicting tensile strength of Hevea latex gloves and guayule latex glove films with varying sulfur content.

FIG. 3 is a graph depicting elongation to break levels in Hevea latex gloves and guayule latex films with varying sulfur content.

FIG. 4 is a graph depicting viscosity of guayule latex and Hevea latex measured by viscometer in rotations per minute (RPM).

FIG. 5 is a graph depicting mechanical stabilization of guayule latex in the presence of differing amounts of two stabilizing compounds.

FIG. 6 is a graph depicting elongation to break of unaged and aged guayule latex films at various sulfur contents, in comparison with unaged and aged Hevea latex films at comparable sulfur contents.

FIG. 7 is a graph depicting modulus properties of unaged and aged guayule latex films at varying sulfur contents, in comparison with aged and unaged Hevea latex films at comparable sulfur contents.

FIG. 8 is a bar graph depicting various properties of unaged and aged guayule latex films, in comparison with aged and unaged Hevea latex films, compared against ASTM D3577-01 Standard Specification for Rubber Surgical Gloves.

FIG. 9 is a graph comparing the physical properties of guayule latex films and Hevea latex films.

FIGS. 10A and 10B are graphs comparing the stretch-relaxation properties of guayule latex films and Hevea latex films.

FIG. 11 is a flowchart illustrating three options for hydrogel coating of guayule latex gloves.

### DETAILED DESCRIPTION

The present disclosure is directed toward a non-Hevea, non-synthetic low-protein latex product that conforms to the specifications for American Society for Testing Materials (“ASTM”) Type I, Type II, or Type III latex products. The present disclosure further provides for a method of determining the properties of a non-Hevea natural latex product in order to assess the substitutability of non-Hevea natural latex products for existing Hevea and synthetic latex products as well as demonstrating the superiority and advantages of the disclosed non-Hevea, non-synthetic, low-protein and low-allergenic latex product. The disclosed method provides a new standard for non-Hevea natural rubber latex (for ease of reference referred to herein as the “Guayule Standard”.) A summary of the Guayule Standard is shown in Table 2. Further, the product disclosed herein is a product that meets or exceeds the standards for the chemical and physical composition of a non-Hevea natural rubber product according to the newly developed and herein disclosed Guayule Standard as shown in Table 2 below.

TABLE 2

| Property Standard | Guayule Latex Standard |
|---|---|
| Color and Odor | Off-white to beige/mild |
| | ammonia smell |
| Total Solids Content (% for commercial | 40-62 |
| viability) (see Example 5) | |
| Dry Rubber Content (% for commercial | 38-62 |
| viability) (see Example 5) | |
| Total Solids Content minus Dry Rubber | 0-2 |
| Content (%) | |
| Total Alkalinity (potassium hydroxide | 0-0.8 |
| as % of latex) (see Example 8) | |
| Total Protein by D 5712 | 0-200 |
| (micrograms/gram dry weight latex) | |
| (see Examples 4 and 7) | |
| Hevea antigenic protein by D 6499 | None |
| (micrograms/gram dry weight latex) | |
| (see Example 4) | |
| pH % (see Example 13) | 7.0-13.0 |
| Mechanical Stability @ 43% TSC, | 90-400 |
| seconds (see Example 14) | |
| Copper (% of total solids) | 0-0.0008 |
| (see Example 15) | |
| Manganese (% of total solids) | 0-0.0008 |
| (see Example 15) | |
| Sludge Content (%) (see Example 10) | 0-0.10 |
| Coagulum Content, (%) (see Example 11) | 0-0.050 |
| KOH Number, Max (see Example 12) | 0-0.80 |

Examples of non-Hevea natural rubber sources include, but are not limited to, guayule (Parthenium argentatum), gopher plant (Euphorbia lathyris), mariola (Parthenium incanum), rabbitbrush (Chrysothamnus nauseosus), milkweeds (Asclepias sp.), goldenrods (Solidago sp.), pale Indian plantain (Cacalia atripilcifolia), rubber vine (Crypstogeia grandiflora), Russian dandelion (Taraxacum sp. and Scorzonera sp.), mountain mint (Pycnanthemum incanum), American germander (Teucreum canadense) and tall bellflower (Campanula america). All of these non-Hevea natural rubber sources are capable of being evaluated according to the disclosed method to determine suitability for use in the disclosed non-synthetic, low-protein, low-allergenic latex products.

In particular, guayule (Parthenium argentatum), a desert plant native to the southwestern United States and northern Mexico, produces polymeric isoprene essentially identical, or of improved latex quality, when compared with Hevea latex. Thus, the terms non-Hevea natural rubber latex and guayule latex are used interchangeably in the present disclosure. Additionally, processed guayule latex has no proteins that contribute to the allergenic properties of Hevea latex. The natural rubber polymers in guayule latex have a high molecular weight and, therefore, products made from this material may be used in high-performance applications.

In its natural state, the sap from the guayule plant is not low in protein. However, a low-protein natural rubber latex can be extracted from guayule with several processing steps. Low-protein guayule latex is produced by removing rubber particles from intact parenchyma cells of the guayule plant in an aqueous suspension. The plant remains in a hydrated state until processing, where it is homogenized in an alkaline aqueous extraction medium. The rubber particles, which have a specific gravity of slightly less than 1, are then purified from the homogenate using a series of centrifugation steps and/or flotation with creaming agents. This process results in natural rubber latex with very little remaining cytoplasmic or soluble protein components.

Additionally, various stabilizers and additives may be used to modify physical properties, storage duration, or quality, depending on desired uses. For example, the addition of sulfur can change the pliability or ‘relaxation’ of the material, by creating sulfur cross-linking between the existing latex polymer chains. Other chemical or stabilizer additions may also be added to guayule latex depending on desired use. Overall, purified guayule latex can remain stable for long periods and may be used to manufacture a wide variety of products, including low-allergenic products for medical use.

Guayule latex has many potential applications in the medical products marketplace because of its low-allergenic properties. The properties include: (1) very little protein, less than approximately 200 microgram (μg) protein/gram (g) dry weight latex overall; (2) no detectable levels of any known Hevea IgE antigenic proteins; (3) the remaining limited amounts of protein are hydrophobic and bound to the rubber phase, limiting the likelihood of absorption into human skin, tissues or extraction into bodily fluids; and (4) none of the protein present in the guayule latex is cross-reactive with latex allergies to Hevea latex (“Type I” latex) products.

Guayule latex is also unlikely to cause long-term latex sensitivity or widespread allergic reactions over time, for a variety of reasons. Historically, well-leached Hevea latex products were extensively used in the medical industry for many decades to protect against the transmission of disease without causing Type I latex allergies, and these products contained much more protein, more than 45 times that of guayule latex products. As human exposure to the product increased, especially to poorly leached products with high levels of soluble protein, a large percentage of the population began to develop allergies. This is unlikely to happen with guayule, which does not contain soluble latex proteins. Guayule latex products, as disclosed herein, also have the physical advantages possessed only by natural rubber materials, and medical products made from it attain or exceed the ASTM D3577-01a physical property standards for Hevea products that could not be reached by the synthetic polymeric materials. These properties also relate to product safety because they improve the strength and elasticity of latex films as well as the fit and feel of products, such as surgical gloves.

First, guayule latex products, according to the present disclosure, contain very little soluble protein, because they are produced by purification of rubber particles from a plant homogenate. Unlike Hevea latex, guayule latex must be purified before it can be used. This process removes non-rubber plant components, including the soluble proteins, as well as water-soluble plant pigments. Guayule latex that has not been sufficiently purified will contain high levels of green and brown colorants. These colorants provide visual cues to the quality and soluble protein level of the latex. Colored latex will be of lower quality insufficient to generate high performance latex and will have a higher level of soluble proteins.

Second, according to the present disclosure, the guayule latex products contain approximately 90 times less total protein than Hevea latex at the same dry weight. Third, the guayule latex products are processed without the need for protein-reducing leaching steps, because the guayule latex products are very low in soluble protein. The majority of any remaining proteins are insoluble or hydrophobic which means that the product will not be absorbed into human skin, as is problematic in unleached or poorly leached Hevea products, where up to 50% or more of the total proteins are hydrophilic or highly soluble. This high solubility is a major contributing factor to sensitization and eventual triggering of an allergic reaction.

By comparison, the amount of soluble protein present in guayule latex is about 45 times lower than even the most well-leached Hevea latex products. Overall, even if only the rubber particle-bound proteins were retained following extensive Hevea latex washing, the Hevea latex would still contain approximately more than 22 times the amount of the total protein in the disclosed guayule latex product. Overall, clinical and performance trials indicate that guayule processing provides a safe, high-performance, low-allergenic natural rubber latex that is safe for human use.

The product disclosed herein is a natural, low-allergenic latex product with overall purity and composition that generally conforms to the ASTM D1076-02 Standard property values for Hevea latex, and that meets or exceeds the Guayule Standard properties disclosed herein and shown in Table 2. Further, the disclosed guayule latex product has a Dry Rubber Content (DRC) that is in a range of about 30% to 65% concentration in water. Guayule Standard property values for non-Hevea latex may include: Total Alkalinity, KOH as a percentage of latex, Copper, Manganese, KOH number, Total Solids Content, Dry Rubber Content, Viscosity, Sludge Content, Coagulum Content, Mechanical Stability, Density, Color, Odor, Protein Content, and Volatile Fatty Acids.

In at least one embodiment, the disclosed product conforms to all the requirements of the presently disclosed Guayule Standard. Further, the disclosed product has very low allergenicity and is for use by humans with latex allergies. Additionally, the product is preventative of allergen sensitization, in that even humans without latex allergies are unlikely to become sensitized to any of the few proteins present in the product—thus less likely to develop any new allergy. In other words, the product has no detectable Hevea antigenic proteins and overall low protein levels, based on assays using standard detection methods.

For example, these standard detection assays may include immunologic measurement of antigenic protein content using ASTM D6499 Standard protocols, ELISA inhibition assays using ASTM D6499 Standard protocols, total overall protein levels using the Modified Lowry Assays using ASTM D5712 Standard protocols, and background subtraction techniques using ASTM D5712 Standard protocols. More specifically, conformance to the presently disclosed Guayule Standard latex requirements includes a product with less than 200 micrograms (μg) total protein per gram dry weight latex, as measured by analysis of aqueous detergent extractable protein. The disclosed Guayule Standard for non-Hevea latex also includes low detectable levels of soluble protein and absence of known antigenic proteins that cross-react with IgE antibodies which trigger Type I latex allergies.

In various embodiments, the product can be used in a variety of medical, consumer, and industrial products. For example, in one embodiment, the product is a non-synthetic, low-allergenic, non-Hevea latex product formed into a film. Generally speaking, forming a latex film requires the coalescence of individual latex particles by the evaporation of the continuous phase (aqueous phase) of the latex material at specific temperatures. Structurally, during evaporation, electrostatic or steric forces that hold the latex particles apart are overcome as charged polymer chain end groups or surfactants are removed. The resulting film is formed by a polymer lattice, with various physical properties depending on evaporation conditions. Example 1 provides one method of producing a film, one example of a product that meets the presently disclosed Guayule Standard.

### EXAMPLE 1

### Dry Films

Air-free, dry, homogeneous films are prepared from concentrated non-Hevea lattices, such as guayule. A mold is constructed by cementing rigid plastic strips 6 millimeters (mm) wide and 1.5 mm thick on a flat glass plate to form a cavity surface that is preferably from 125 to 150 mm square. Dry films 1 mm thick will result when the mold is filled with latex at 62% total solids content (TSC) and about 0.7 mm can be produced with 48% TSC latex. Tests are then performed to compare non-Hevea and Hevea latex films according to standard techniques, pursuant to ASTM D1418 and D1566 Standards.

In one embodiment of film preparation, the mold is formed by cementing plastic strips to a glass plate with epoxide resin adhesive or polyvinyl acetate dissolved in methyl ethyl ketone. A wood or stainless steel straightedge is used to scrape the surface of latex in the mold free of air bubbles. Thin transparent cellulosic film sheets are used to cover and protect the dry rubber films.

The film is prepared without dilution if the TSC is about 62% or less. If the TSC is above 62%, the latex is brought down to this value by dilution with distilled water. Latex is mixed well in the sampling bottle and allowed to stand for five minutes. Latex is then carefully strained through a 180-ml stainless steel sieve with a nominal aperture of 0.180±0.009 mm (0.0070±0.0004 in.) into a 50-ml glass beaker, covered, and allowed to stand for five minutes before pouring into the mold. The mold is placed into the position in which the film will be left to dry. Immediately before pouring the latex into the mold, the cover is removed from the beaker and the latex surface is scraped free of foam with a piece of filter paper. Keeping the beaker close to the plate, the latex is poured into the mold in a continuous stream, distributing the latex evenly in the mold cavity to fill the mold completely. The latex is allowed to stand in the mold for one minute and then a clean wood or stainless steel straightedge is scraped across the mold.

In this embodiment of film preparation, the cast is allowed to dry at room temperature first, and then in an oven at a temperature not exceeding 35° C. When sufficiently dry to remove the film from the mold without distortion, the film is stripped from the mold, taking care to handle the surface of the film as little as possible, turned over, and placed on a piece of thin, transparent cellulosic sheet. The film is allowed to dry for at least another 24 hours at a temperature not exceeding 35° C. and then covered with another piece of cellulosic sheet. Film dryness is judged by clarity, which increases as the film becomes drier. If there is any doubt about dryness with visual examination, the film is dried to constant mass at a temperature not exceeding 35° C. in a dry atmosphere. The film is stored until required for testing in a cool, dark place in an air-tight container or desiccator to prevent absorption of moisture.

In another embodiment, the method is directed to the production of a non-Hevea, non-synthetic, low-protein latex glove with high elongation properties. For example, in this embodiment, the glove will have expansion properties that allow manufacture of a limited number of sizes without compromising fit to the wearer's hand. In this example, the glove will stretch to fit a large range of hand types and sizes and will require a smaller number of sizes to be manufactured. In one example of this embodiment, the glove sizing is based on hand volume size not hand length.

Latex gloves products, according to the present disclosure, include both exam gloves and surgical gloves. Surgical gloves differ from exam gloves in many ways. Although they are similar in design, the requirements for end-use are quite different. While exam gloves are used for undemanding, routine procedures (changing a bandage, venipuncture, handling specimens, etc.), surgical gloves are used for long surgical procedures which may last several hours in duration. Thus, surgical gloves must be durable to maintain barrier properties yet remain flexible and soft for comfort. Tactile sensitivity is critical for surgical procedure. Properties of elastic recovery are also key because of delicate procedures where suturing or other manipulation is required. Many synthetic materials (such as nitrile) maintain a crease in the fingertips, which detracts from tactile sensitivity. Thus, surgical gloves comprised of synthetic polymers lack the desired tactile properties necessary to be considered high quality or demonstrate optimal performance.

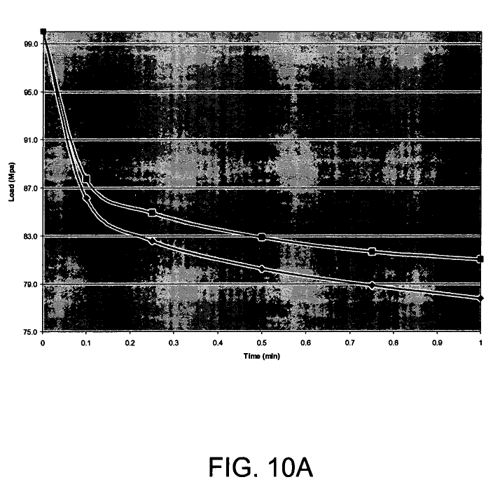

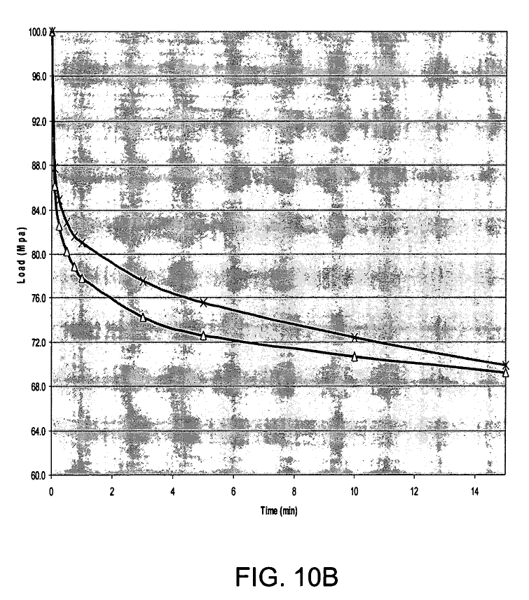

However, surgical gloves comprised of the non-synthetic latex disclosed herein demonstrate tactile and elastic recovery properties far superior to those surgical gloves comprised of synthetic polymers. As shown in FIGS. 10A and 10B, measuring the stretch relation of guayule latex versus Hevea latex from 0-1 minutes (FIG. 10A) and then from 0-15 minutes (FIG. 10B), resulted in less relaxation and movement than Hevea when stretched over time. Also, the results demonstrate that guayule latex imposes less fatigue on a human hand when a glove is worn over an extended period of time. Further, as illustrated below, both exam and surgical gloves comprised of the non-synthetic latex disclosed herein are softer than Hevea or synthetic gloves, as measured by the modulus of the latex film (discussed below).

Further, surgical gloves should be powder free. A powder-free guayule latex glove films may be produced from a powdered product by different methods including (1) Online/Offline Chlorination and (2) Alternative Offline Chlorination.

For Online/Offline Chlorination, while the glove film is still on the form just after exiting the curing oven, the film is post-cure leached (water temp. 40 C-60 C), mildly dried to remove surface moisture. The films are immersed first into a dilute HCl solution bath (maintained between pH 2-5), followed by immersion into a bleach (sodium hypochlorite, 3% to 6% slon.) solution bath. Subsequently, the film is dipped into a water bath or dilute caustic to neutralize the chlorination reactants. Maintaining the parameters in the ranges specified above, the chlorine strength should be between 500 ppm to 4000 ppm. Reducing the pH of the acid solution will increase the strength of the chlorine solution, and vice versa.

Alternatively, the HCl and bleach baths may be replaced by a single bath consisting of chlorine gas injected into water to a concentration of 500 ppm to 4000 ppm. This bath would be followed by the water/neutralizer bath. The films would then be completely and stripped from the form. The films post-stripping would be rendered “grip-side” out. In an offline chlorination unit, the films would then be chlorinated on the grip side yielding a fully powder-free glove. Chlorination is carried out using chlorine gas injected into a water stream to a concentration range of 200 ppm to 2000 ppm chlorine.

For the alternative method of Offline Chlorination, while the glove film is still on the form following pre-cure leaching, the film is immersed into a calcium carbonate slurry which when dried during the curing will become the powder that facilitates removal of the film from the form. The glove film is removed from the form and inverted to don-side out in order to chlorinate this side first.

In an offline chlorination unit, the films would then be chlorinated on the don side first. Chlorination is carried out using chlorine gas injected into a water stream to a concentration range of 200 ppm to 2000 ppm chlorine. Depending on the application, the films may be reverted to grip-side out and chlorinated a second time on this side. Chlorine concentration range would be 100 ppm to 1500 ppm. After the neutralization and water rinsing, the films are dried thus yielding a fully powder-free glove.

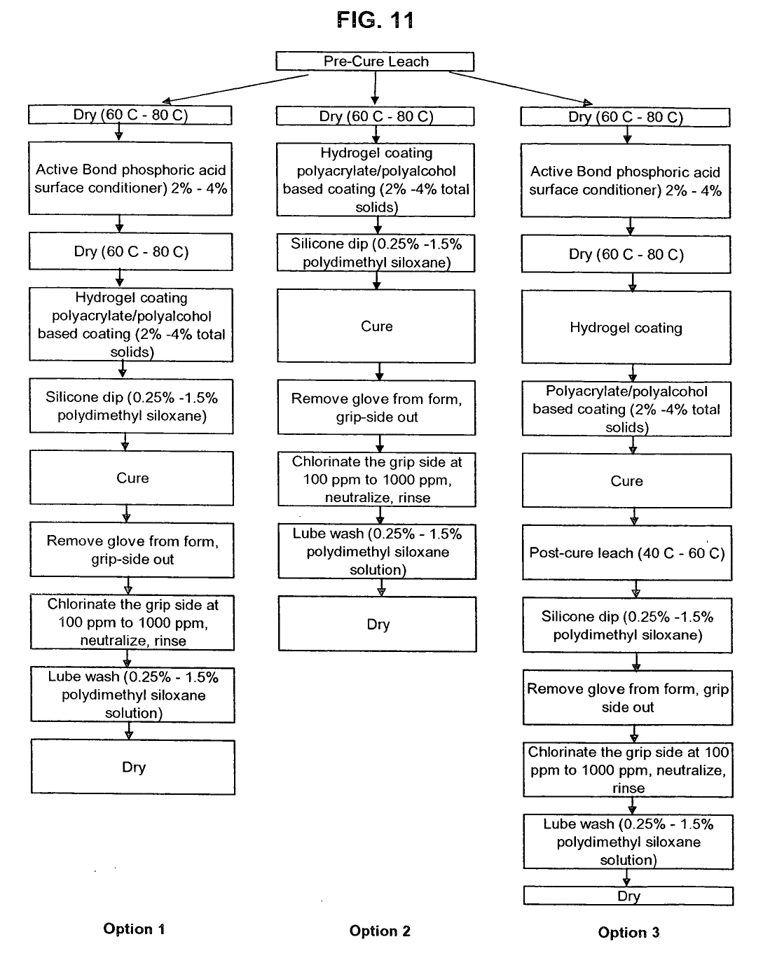

Further, gloves can be coated with hydrogels. As shown in FIG. 11, at least three optional methods of hydrogel coating of guayule latex products are disclosed herein. As shown in FIG. 11, Option 1 is the basic procedure for the hydrogel coating application; Option 2 shows an alternate procedure whereby the active bond surface conditioner is omitted from the process; and Option 3 includes an additional online leach. The inclusion of this leach required the silicone dip to be moved to a point after the additional leach.

In an additional embodiment, the method further includes a step for coating a Hevea or synthetic latex product. For example, in this embodiment, the method includes one or a plurality of layers that cover all or a portion of a Hevea or synthetic latex product. In another example, the method includes one or a plurality of layers that cover all or a portion of any article made from a compound other than a non-Hevea natural rubber source, e.g., plastic, metal, wood, ceramic, alloy, and the like. In at least one embodiment of this method, the article is dipped, sprayed or otherwise coated in a guayule latex coating to provide a barrier between the article and the user's skin. In other embodiments, the method further includes ‘sandwiching’ the article between top and bottom coatings of non-Hevea latex. In one additional specific embodiment, the method includes a final step of dipping or coating a Hevea latex or synthetic latex film (e.g., a glove) with a non-Hevea latex.

In another embodiment, the product is directed to a non-Hevea, non-synthetic low-protein latex product for use in medical devices such as catheters, medical adhesives, latex wound care-products, laboratory testing equipment, assays, disposable kits, drug containers, syringes, valves, seals, ports, plungers, forceps, droppers, stoppers, bandages, dressings, examination sheets, wrappings, coverings, tips, shields, and sheaths for endo-devices, solution bags, balloons, thermometers, spatulas, tubing, binding agents, transfusion and storage systems, needle covers, tourniquets, tapes, masks, and stethoscopes, compression bands, ties, and straps, inflation systems, braces, splints, cervical collars, and other support devices, belts, clothing, and the padding on wheelchairs and crutches.

While synthetic materials such as silicone rubber, polyurethane and synthetic polyisoprene, are used in some of the hundreds of specialized product applications for catheters (especially balloon catheters), some of these materials cannot maintain constant pressure when required. In addition, some synthetics do not have the structural integrity to maintain rigidity for extended periods of time. Bursting of balloon catheters during a surgical procedure can be life threatening. Medical devices comprised of the disclosed non-synthetic latex have superior structural integrity and avoid these life-threatening problems.

In a further embodiment, the product is directed to dental tools and products such as dental dams. The biggest problem with current dental dams is that they are all constructed from Hevea latex. Because of the particular manufacturing process used in making dental dams, the Hevea latex cannot be properly leached, resulting in a latex product high in soluble proteins. This is extremely dangerous for dental dams which are used as draping material for oral procedures and come in close contact with mucosal tissue. Such contact of poorly-leached, highly-sensitizing and highly-allergenic latex can result either in rapid sensitization and/or severe allergic reaction. Because of the low-allergenicity of the disclosed dental dams comprised of guayule latex, this danger is avoided.

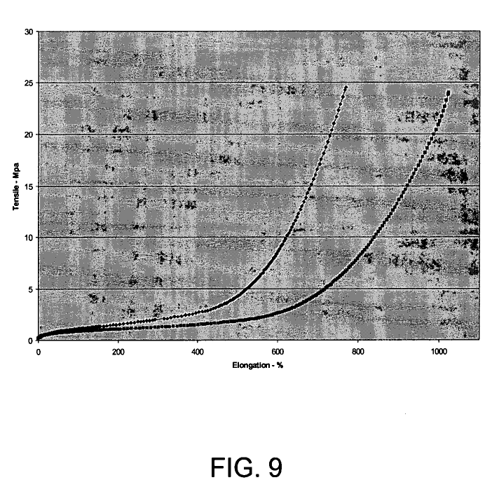

In yet another embodiment, the product is directed to barrier devices for birth control, such as condoms, both male and female, diaphragms, cervical caps and contraceptive sponges. Condoms, made with guayule latex according to the present disclosure, are less susceptible to the common breakage problems often encountered with condoms made from synthetic polymers. FIG. 9 graphically depicts the comparison of the physical properties of guayule latex and Hevea latex. As shown in FIG. 9, while guayule latex has similar tensile properties as Hevea, guayule latex has higher elongation and more elasticity than Hevea latex, thus demonstrating superior ability to stretch before breaking. Also, condoms comprised of the non-synthetic latex disclosed herein are softer than synthetic condoms, as measured by the modulus of the latex (discussed below), and provide for greater comfort during use.

In a further embodiment, the product is directed to products and processes for use in non-residential settings such as nursing homes, treatment centers, spas, hospitals, nurseries, clinics, doctor and dental offices, day care settings, and schools. In this embodiment, the product may include medical devices or other items specific to the industry or population served.

In still another embodiment, the product is directed to industrial products and processes such as extrusions, paints, films, coatings, sheeting, building materials, sealants, packaging, production equipment, transfer equipment, and containers. In a further embodiment, the product is directed to household uses such as children's items, office supplies, and health and beauty items such as condoms, applicators, cosmetics, and dental care products. In other embodiments, the product is directed to storage containers, food, beverages, and electronic equipment. Finally, the product is a non-Hevea, non-synthetic, low-protein substitute for any existing product currently comprising Hevea or synthetic latex.

As described in Example 2, the protein content of guayule latex products, as disclosed herein, is substantially lower than that of well-leached Hevea latex products. The low protein levels, resulting from a latex washing process which removes all soluble and hydrophobic proteins that are not bound to the rubber particles, coupled with the hydrophobic nature of the remaining proteins, decrease the potential for allergic reactions in latex-allergy prone individuals. The remaining hydrophobic proteins are associated with the rubber particle membranes which, therefore, are far less likely to cause allergic reactions. Additionally, as the following examples illustrate, in comparison to Hevea latex, the guayule latex product disclosed herein contains rubber polymers of similar molecular weight. Further, guayule latex forms very little insoluble gel because it is a less branched polymer. Finally, guayule latex products, as disclosed herein, may be more viscous than Hevea latex at any comparable percentage Dry Rubber Content (“DRC”). However, any difference in viscosity that may be seen can be overcome with additives such as surfactants. Guayule latex products also have a substantially lower protein content, and have similar strength and flexibility characteristics.

### EXAMPLE 2

### Physical Property Comparison of Guayule Latex and Hevea Latex Glove Films

Guayule latex glove films are made using the following protocol. A glove former is preheated to 75° C. and dipped in a coagulant comprised of 17% CaNO₃, 4% CaCO₃, 0.2% surfactants at 45° C. with no dwell time. Coagulant is dried for one minute at 75° C. The former is then dipped into the compounded latex (33% TSC, room temp.) with a ten count dwell time to form a film. The film-coated formers are dried for six minutes at 75° C., bead rolled to form a cuff, and then leached for two minutes at 50° C. The films are then cured for fifteen minutes at 110° C., removed from the former and chlorinated. Physical composition and content is then measured for guayule latex glove films, made as described above. Guayule latex films are measured in comparison to commercially available chlorinated Hevea latex glove films, using standard techniques to measure swell, modulus, tensile strength and elongation to break. Mechanical stability and viscosity are previously measured on the guayule latex itself.

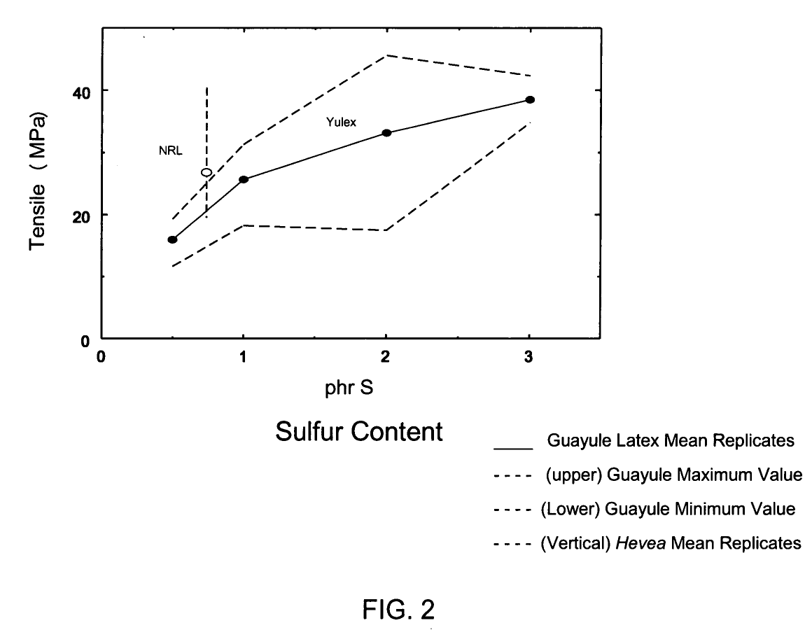

1. Tensile Strength: Eight replicates of Hevea latex gloves are compared to eight replicates of guayule latex gloves with various percentages of sulfur concentration. Tensile samples are cut 10 mm wide, perpendicular to its direction on the form, and tested according to standard techniques disclosed below. As shown in FIG. 2, Hevea latex gloves have an ultimate tensile strength of 22-30 megapascals (MPa), while the guayule latex gloves show that tensile strength levels increases as sulfur content increases.

2. Swell: Swell tests are also performed using standard techniques to measure linear swell in guayule latex gloves containing various contents of sulfur. Guayule latex film swell is then compared to published standards for Hevea latex at various levels of vulcanization. As shown in Tables 3 and 4, full state of cure can be obtained using rubber chemistry tailored to the desired properties of guayule latex. Results indicate that unaged guayule latex films will reach a full state of cure without additional processing. Swell in guayule latex gloves is comparable to Hevea latex product standards. As shown in Tables 3 and 4, linear swell tests for Hevea latex films have values greater than 160% for unvulcanized films, 100-159% for lightly vulcanized films, 80-99% for moderately vulcanized films, and below 80% for fully vulcanized materials.

TABLE 3

Guayule latex
films

| Testing Standard | | | % Linear |
|---|---|---|---|
| Hevea Latex | % Linear Swell | phr S | Swell |
| Unvulcanized | ≧160% | 0.5 | 100 |
| Lightly Vulcanized | 100%-159% | 1.0 | 92 |
| Moderately Vulcanized | 80%-99% | 2.0 | 82 |
| Fully Vulcanized | ≦79% | 3.0 | 80 |

TABLE 4

| | |
|---|---|
| Guayule Latex Films | Hevea Latex Films |

| phr S | Unaged | Aged | Unaged | Aged |
|---|---|---|---|---|
| 0.5 | 100 | 96 | 84 | 72 |
| 1.0 | 92 | 84 | 80 | 72 |
| 2.0 | 82 | 80 | 76 | 68 |
| 3.0 | 80 | 80 | 76 | 68 |

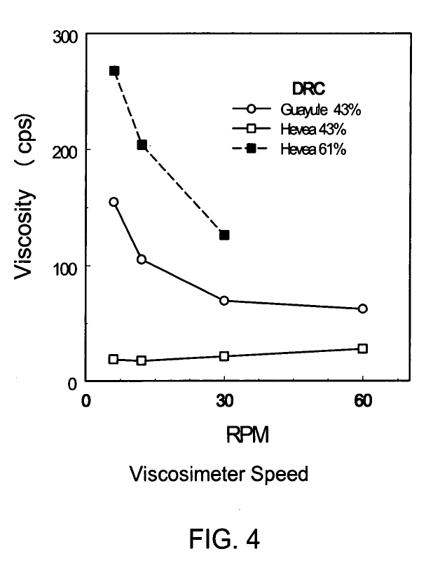

3. Viscosity: A comparison of viscosity between Hevea latex and guayule latex is performed using plate-to-plate rheometry techniques and by viscometer. Plate-to-plate rheometry is performed using standard techniques known in the art. Viscometer testing is performed using a Brookfield LVDV-II+ viscometer (Brookfield Engineering, Inc., Stoughton, Mass.) in which viscosity is measured by the resistance to a rotating spindle. Results from viscometer trails indicate guayule latex is more viscous than Hevea latex at any particular percent DRC, measured in centipoises (cps), as shown in FIG. 4. The higher viscosity, attributable to the larger particle size of the latex, may result in an improved dipping process, in terms of improved pick-up, lower residence time and faster line speeds. However, it is also possible with the addition of suitable additives, such as surfactants, to reduce the viscosity of guayule latex, if desired.

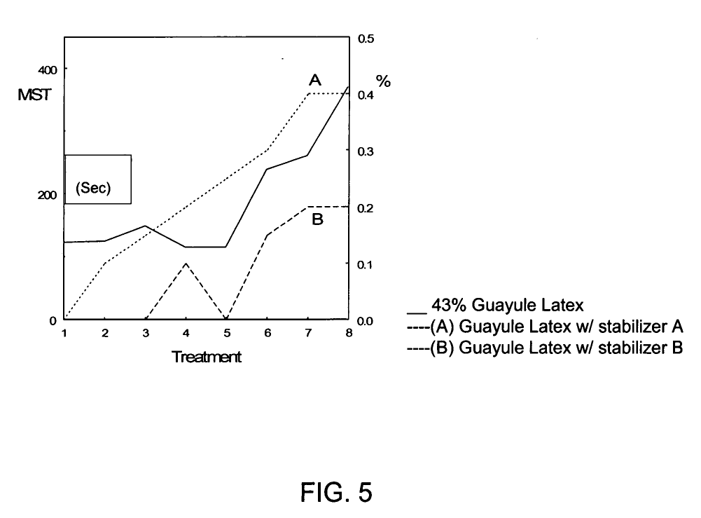

4. Mechanical Stability: Guayule latex rubber particles have a mean particle diameter of about 1.4 μm in contrast to Hevea particle diameter of about 1.0 μm. Differences in particle size attribute to higher latex viscosity and lower TSC in guayule latex in comparison with Hevea latex. Mechanical stability of latex film lattices can be measured using ASTM D1076-02 Standard procedures where TSC exceeded 55%. However, to compensate for this, guayule latex with TSC of less than 55% is measured using techniques disclosed below. The mechanical stability of both lattices at a similar % TSC gives comparable results, as shown in FIG. 5. Guayule latex samples tested at a TSC value of 43%, had mechanical stability times (MST) up to 370 seconds. Comparatively, samples of Hevea latex at 62% TSC have MST values of approximately 1,175 seconds and Hevea latex at 46% TSC have MST values of approximately 130 seconds.

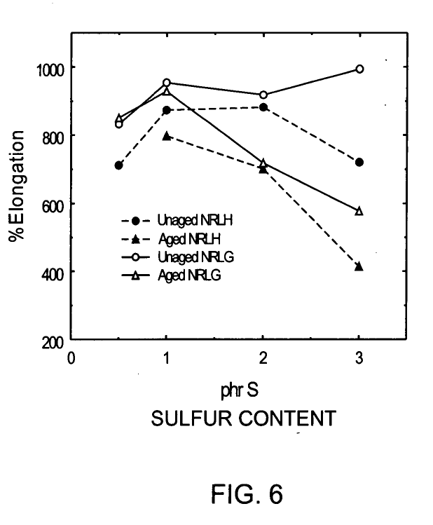

5. Elongation to Break: Elongation-to-break properties of unaged guayule (Unaged NRLG) and aged guayule (Aged NRLG) latex at varying sulfur contents are compared with aged Hevea (Aged NRLH) and unaged Hevea (Unaged NRLH) latex at comparable sulfur contents using standard elongation-to-break techniques, as shown in FIG. 6.

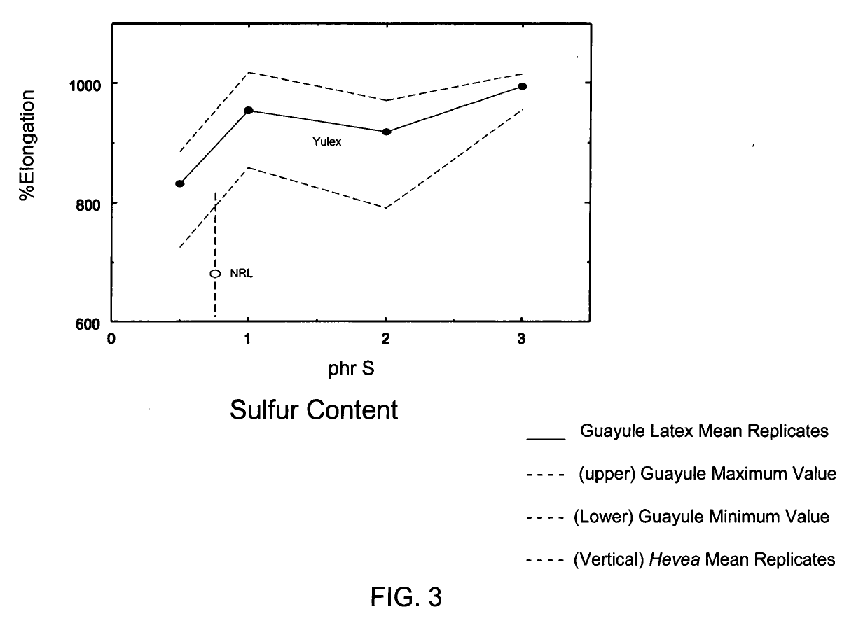

In one trial, eight replicates of Hevea latex gloves are compared to eight replicates of guayule latex gloves with varying sulfur contents. As shown in FIG. 3, Hevea latex gloves have elongation to break of 700-800%, while the guayule latex elongation-to-break levels correlate to sulfur content. In another set of trials using standard elongation-to-break techniques, guayule latex films, as shown in FIG. 6, exceed the ASTM D3577 Surgical Glove Standard at even the highest sulfur level of 3 phr (sulfur content) and have superior elongation to break when compared with Hevea latex. The high elongation-to-break values of the guayule latex films indicate a high level of stretchiness in these films. Comparably, synthetic latex gloves have a tensile strength of approximately 25-35 MPa and an elongation to break of approximately 550-675%.

6. Modulus: The properties of a continuous film depend on formation temperature and additives which affect its elastic modulus, or resistance to particle deformation. Elastic modulus of the film affects its application, and generally a moderate modulus level is appropriate for uses such as latex gloves (as indicated in the ASTM D3577 Standard). Modulus reflects the strength of the film combined with its softness and tactile feel. Films with a high modulus have a tendency to crack and fissure, while films with a very low modulus are tacky and are suitable as adhesives.

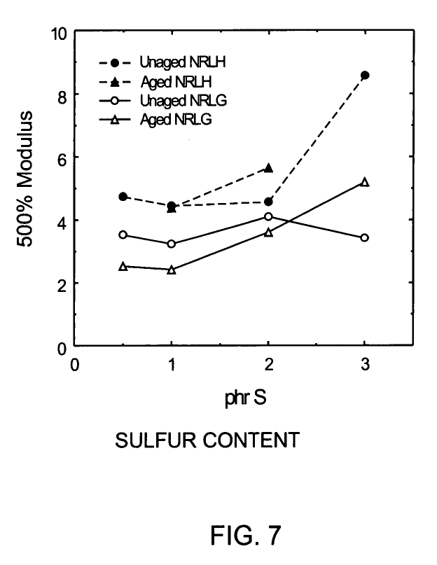

Modulus properties of unaged guayule (Unaged NRLG) and aged guayule (Aged NRLG) latex at varying sulfur contents are compared with aged Hevea (Aged NRLH) and unaged Hevea (Unaged NRLH) latex at comparable sulfur contents using standard techniques. As shown in FIG. 7, unaged guayule latex films reach a maximum at 2 phr sulfur, indicating an optimal ratio of the compound to the sulfur. These unaged guayule latex films have almost as high a cross-link density as the 3 phr films, as shown in Table 5. As shown in FIG. 7, the maximum modulus at 2 phr indicates a maximization of mono-sulfidic links compared with that of the 3.0 phr unaged Hevea latex films. Additional sulfur content allows more poly-sulfidic links between latex polymer chains, resulting in a lower modulus. The aged guayule latex films are even softer than the unaged Hevea films except at the highest sulfur content. The Hevea films are consistently less soft than the guayule films at all sulfur levels. The Hevea films fail the ASTM D3577 Standard, at the highest sulfur content, while guayule latex films still meet or exceed ASTM standards.

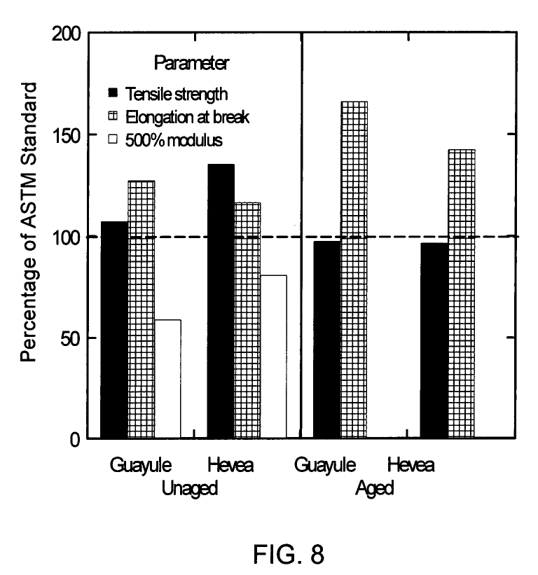

Overall, results indicate that the guayule latex product outperforms the synthetic materials, and has physical properties at least comparable to Hevea latex, as shown in FIG. 8. Furthermore, guayule latex products meet or exceed ASTM D3577 Standards for surgical gloves, as shown in Table 5.

TABLE 5

| ASTM D3577 | UnAged Films | Aged Films |
|---|---|---|
| Minimum Tensile Strength (MPa) | 24 | 18 |
| Minimum Elongation to break (%) | 750 | 560 |
| Maximum 500% Modulus | 5.5 | N/A |

### EXAMPLE 3

### Method of Determining Properties of a Guayule Latex Product

In another embodiment, the method is a method of determining the properties of a non-synthetic, low-allergenic, non-Hevea latex product. In this method, the physical or chemical properties of low-allergenicity of a non-synthetic latex product processed from a natural non-Hevea rubber source are determined, based on the presence of proteins and other physical and chemical properties. More specifically, this method is used to measure natural non-Hevea rubber processed and concentrated either by centrifugation or a combination of centrifugation and creaming. In various embodiments the method disclosed herein is used to monitor physical properties and composition of the latex product at one or more stages in the production, storage, transfer, or manufacturing process.

Generally, extracted latex for industrial or medical uses, including those of the present disclosure, is tested for conformity to the standard specifications of various regulatory bodies, including the ASTM D1076-02 Standard values. The Guayule Standard, as disclosed herein, provides a standard table listing a number of physical or chemical properties. Each of these properties is associated with a numeric or written value to indicate the standard minimum or maximum amount allowed for a latex product to conform to the requirements for that category. Written values provide a method of quantification where measurement by numeric value is difficult or impossible (e.g., the words ‘absent’ or ‘present’ are written values.) Each of the properties is measured according to standard methods, as required in the Guayule Standard. More specifically, the method disclosed herein is directed to testing non-Hevea latex products according to Guayule Standard protocols, for the following chemical and physical properties, including: Total Solids Content (%) (Example 5); Dry Rubber Content (%) (Example 6); Total Alkalinity (Example 8); Viscosity; Sludge Content (Example 10); Coagulum Content (Example 11); KOH number (Example 12); pH; Mechanical Stability (Example 14); Copper (ppm) (Example 15); Manganese (ppm) (Example 15); and Density (mg/m³).

The purity of the processing stages or final guayule latex product is tested by determining the concentration of the protein in the aqueous phase of the latex, through methods disclosed below, including latex protein analysis and Hevea antigenic protein analysis. Overall purity or composition requirements are dependent on the use of the final latex product; however, generally, a benchmark standard for the final product includes general conformation to the Guayule Standard for non-Hevea, for a dry rubber content percentage above 40 wt % latex rubber concentration in water.

The method disclosed herein sets forth methods for the testing low-allergenic non-Hevea latex in each category, as described below. In various embodiments of the method, the samples may be prepared from open-head drums, closed-head drums, tank cars, or other containers, and are preferably agitated with a high-speed stirrer for about 10 minutes. In one embodiment, samples may be removed from storage containers by slowly inserting a clean, dry, glass tube 10-15 millimeter internal diameter and open at both ends, until it reaches the bottom of the container and contents may be then transferred to a clean, dry sample bottle. In other embodiments, samples may be removed using a metal sampling tube, a vacuum unit, a remotely operated sampling collector, or other collection method. In one embodiment, samples are collected from various parts of the container and combined prior to testing.

### EXAMPLE 4

### Protein Presence and Cross-Reactivity of Guayule Latex Films

Protein composition and content may be measured for guayule latex, using mice and rabbit models as well as in human clinical trials, using assay standard techniques, and compared with Hevea latex. In various embodiments, allergenic Hev-b protein assays may be performed using ELISA (enzyme-liked immunosorbent assay), 1-D and 2-D immunoblots, skin-prick tests, radioallergosorbent blood allergy testing (RAST®) assays, ImmunoCAP System (“CAP”) (Pharmacia, Kalamazoo, Mich.) assays, or modifications of these, in order to detect the presence and amount of common allergenic Hev-b proteins.

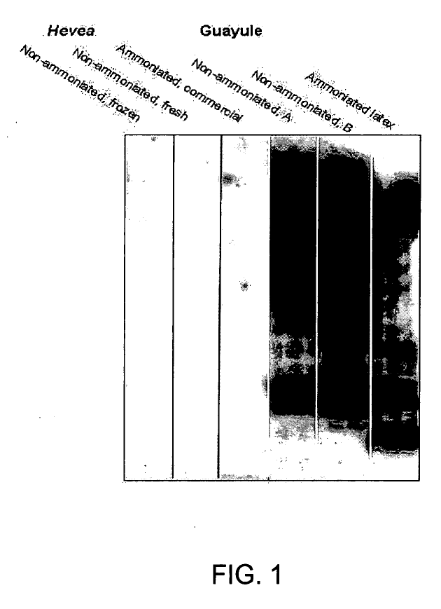

For example, as shown in FIG. 1, immunoblots are prepared using anti-guayule rubber particle total protein rabbit polyclonal IgG antibodies against proteins from different latex samples, including three Hevea latex samples and three guayule latex samples. Reciprocal tests using mice and rabbit antibodies demonstrate that antibodies deliberately raised against extracted and concentrated guayule latex proteins do not cross-react with Hevea latex proteins.

In another example, protein content of guayule latex is compared with two samples of Hevea latex in three replicates. The total protein in the lattices is quantified using the Modified Lowry test described ASTM D5712 Standard protocols. As shown in Table 6, guayule latex contains very little protein (<2%) overall, and compared with Hevea latex.

TABLE 6

| Sample | Protein (μg/g dry rubber) |
|---|---|
| Hevea, sample 1 | 9,636 |
| Hevea, sample 2 | 9,196 |
| Guayule sample | 106 |

In yet another example, CAP (Pharmacia, Kalamazoo, Mich.) assays may be used to determine the presence and amount of Hev-b proteins in guayule latex gloves and compared with two brands of Hevea latex gloves, Redline gloves (Redline Medical Supply, Golden Valley, Minn.) and Triflex surgical gloves (Allegiance Healthcare/Cardinal Health, McGaw Park, Ill.), and synthetic gloves.

For the CAP assay, first, human sera are prepared using human serum pools. Examples of human serum pools include the following: (1) Pediatric: a human IgE anti-Hev-b serum pool is prepared from subjects who had participated in a Hevea brasiliensis C-serum skin testing study. This pool is combined with serum from 53 children with spina bifida with a positive clinical history of latex allergy and a positive skin test and/or IgE anti-latex serology (Hamilton et al., 1999). The two human serum pools are pooled to make a pediatric IgE anti-latex pool. (2) Adult: a human IgE anti-Hev-b serum pool is prepared from subjects who had participated in a Hevea brasiliensis C-serum skin testing study. This pool is combined with serum from 180 adult healthcare workers, who were known to have a Hev-b latex allergy based on a positive history, a positive skin test, and IgE anti-latex serology. These are pooled to make the adult IgE anti-latex serum pool.

More specifically, in this example, using the pools disclosed above, the pediatric and adult serum pools contain 19 kIU/L (measuring units of allergen per liter) and 63 kIU/L respectively of IgE anti-latex (as measured by the CAP assay.) A CAP assay is then performed to detect IgE anti-Hev-b latex inhibition on three guayule latex preparations and their appropriate controls, using control Hev-b E8 as a non-ammoniated latex reference. All extracts were tested for detectable Hev-b cross-reactive allergen. Examples of reagents include Hev-b latex serological reagents (e.g., K82 latex CAPs, ImmunoCAP System) optimized with the Hev-b proteins that are most commonly identified as allergens, as disclosed above.

More specifically, in this embodiment, 0.1 ml of test guayule, synthetic, or known Hev-b positive glove material is incubated with 0.1 ml of human serum containing IgE anti-Latex. Each human IgE anti-latex serum pool is analyzed in a separate assay. Twelve dilutions of the E8 non-ammoniated Hev-b latex are incubated with buffer (in duplicate) to construct a latex allergen dose response curve from which ImmunoCAP results obtained with the test preparations are interpolated. Following this first incubation (4 hrs at 23° C.), each mixture is pipetted into its own latex-allergosorbent (K82 latex-ImmunoCAPs Pharmacia, Kalamazoo, Mich.) in duplicate. The CAP assay is then completed as defined by manufacturer with detection of the amount of bound IgE by the addition of labeled anti-human IgE. The assay is designed so that if Hevea latex cross-reactive material is present in any of the test preparations, it would bind IgE anti-Hevea latex antibody and competitively inhibit it from subsequently binding to the solid-phase latex allergen. Differences in the levels of IgE anti-latex inhibition obtained with the test preparations are compared with negative neoprene and vinyl glove extracts. Results are then analyzed for IgE anti-Hev-b latex inhibition.

Using the foregoing human serum pools as an example, the levels of Hev-b cross-reactive allergenic protein in the ammoniated guayule latex, two latex glove controls, and a neoprene synthetic glove are determined with the ImmunoCAP inhibition assay, using the adult and pediatric serum pools, respectively. No Hev-b cross-reactive allergen is detected in the ammoniated guayule latex preparations (containing solubilized rubber particle-bound proteins from the latex). Additionally, no Hevea cross-reactive proteins are detected by the CAP inhibition assay in ammoniated guayule latex using either the adult and pediatric IgE anti-Hevea latex serum pools. A basic t-test is performed, and the degree of inhibition is not significantly different from the neoprene negative control extract (<1 AU ml⁻¹). The two brands of Hevea latex gloves produce 1,812 and 1,283,900 AU ml⁻¹ of detectable allergen, respectively. This indicates an absence of detectable cross-reactive allergenic protein in the ammoniated guayule preparations.

Overall, guayule latex contains none of the known cross-reactive epitopes known to trigger a Hevea-type allergic response. As shown above, and in FIGS. 1A and 1B, guayule latex proteins do not cross-react with anti-Hevea latex protein antibodies at concentrations at least 1,000 times the amount of protein sufficient to cause a response to Hevea proteins in allergic human patients.

The following Examples 5-15 illustrate specific examples of how the physical and chemical properties of a non-Hevea latex product are determined according to the disclosed method.

### EXAMPLE 5

### Method for Measuring Total Solids in a Non-Hevea Latex Product

In order to determine the total solids content (TSC) of Guayule latex, the following procedure can be used. In one example, approximately 2.5±0.5 grams of guayule latex is weighed in a tared, covered weighing dish approximately 60 mm (2.5 in.) in diameter, and 1 cm³ distilled water is added to the latex by gently swirling the dish. Latex is distributed at the bottom of the dish over an area of approximately 32 cm² (5 in.²). The specimen is dried in an uncovered dish in a vented air oven for 16 hours at 70±2° C. or 2 hours at 100±2° C. The cover is replaced and the sample is cooled in a desiccator to room temperature and then weighed. Drying and weighing is repeated until the mass is constant to 1 mg or less. Tests are run in duplicate and checked within 0.15%. The average of the two determinations is taken as the result. The percentage of total solids is calculated as follows: Total solids, %=[(C−A)/(B−A)]×100, where A=mass of the weighing dish; B=mass of the dish plus the original sample; and C=mass of the dish plus the dried sample.

### EXAMPLE 6

### Method for Measuring Dry Rubber Content in a Non-Hevea Latex Product

In order to determine the Dry Rubber Content (DRC) of Guayule latex, the following procedure can be used. In one example, approximately 10 grams of guayule latex is weighed into a porcelain evaporating dish approximately 100 mm in diameter and 50 mm deep, and acetic acid aqueous solution (20 Mg/m³) is added with distilled water until the total solids content is approximately 25%. Acetic acid (2%) is then added, while stirring constantly for 5 minutes, to completely coagulate the latex (to approximately 80 cm³). Up to 20 ml hydrochloric acid (2%) may additionally be added to improve coagulation. The dish is then placed in a steam bath for 15 to 30 minutes until a clear serum results. Coagulated latex particles are then picked up with the main body of the coagulum and washed in running water. This process is repeated until the sheet of coagulated rubber reaches a maximum thickness of 2 mm.

The sheet is then dried at 70±2° C. in a vented air oven atmosphere. If oxidation occurs, the test may be run with the option of using a drying temperature of 55±2° C., or an antioxidant may be added to the latex before coagulation. The sheet is finally cooled in a desiccator to room temperature and weighed. Drying and weighing steps are repeated until the mass is constant to 1 mg or less. To measure dry rubber content, multiple samples are run and checked within 0.2%. The average of the samples is taken as the result, and dry rubber content is calculated according to the following equation: Dry rubber content, %=mass of dry coagulum/mass of sample×100.

### EXAMPLE 7

### Method for Measuring Protein Content in a Non-Hevea Latex Product

Total protein content is measured by solubilizing latex proteins in 1% SDS and 50 mM sodium phosphate buffer (final concentration) and then quantified using the modified Lowry test according to ASTM D5712 Standard protocols. In the solubilization method, latex samples (500 μl) are mixed with 450 μl 100 mM sodium phosphate buffer (1:1) into three microfuge tubes for each sample; and 50 μl 20% SDS is added into each tube, mixed; and incubated at 25° C. for 2 hours on a 200 rpm shaker. After incubation, the samples are spun for five minutes, and the aqueous phase is transferred into new tubes and spun again to clarify the latex. The samples are then divided into 3×0.6 ml tubes for each sample (these can be stored at 4° C. overnight). Also, standards of bovine serum albumin (BSA) are prepared in extraction buffer at 0, 5, 10, 15, 25, 50, 100, 200, 300, 400 μg/ml. Additionally, 60 μl 1.5 mg/ml sodium deoxycholate is added to the samples and standards, mixed, and allowed to stand for 10 minutes. 120 μl of 72% freshly mixed trichloroacetic acid and phosphotungstic acid (1:1) is then mixed into each sample and standard, incubated for 30 minutes at room temperature, and spun for 15 minutes to remove supernatant. Each protein pellet is then air dried, suspended in 250 μl 0.2 M sodium hydroxide, and stored at 4° C. until assayed. Assays are performed within 24 hours using the modified Lowryy test according to ASTM D5712. Assays for Hevea antigenic protein may also be performed by solubilizing latex proteins with 1% SDS and 50 mM sodium phosphate buffer (final concentration) and quantified using the antigenic protein assay according to ASTM D6499 Standard protocols.

### EXAMPLE 8

### Method for Measuring Total Alkalinity in a Non-Hevea Latex Product

In one embodiment, total alkalinity in guayule latex is measured using a glass electrode pH meter and 0.1M (molar) standard HCl. Samples are first prepared by weighing 5 grams of latex into a glass weighing bottle of approximately 10-cm³ capacity, having a ground glass cap, and weighed to the nearest 1 mg. The specimen is poured into a beaker containing approximately 300 cm³ of distilled water, stoppered to prevent loss of ammonia, and set aside for reweighing. The specimen mass is equal to the difference between the two weights. Samples are then transferred to a beaker with minimal loss of latex.

Electrodes from the calibrated glass electrode pH meter are inserted into the liquid to measure pH. The meter is then calibrated and the pH measurements made in accordance with Test Method E 70, according to manufacturer directions. While stirring, 0.1 M hydrochloric acid (HCl) is slowly added until the solution reaches 6.0 pH. With samples of unknown alkalinity, HCl is added in 1-cm³ increments, and pH readings are taken every 10 seconds. In another embodiment, the sample is prepared as described above, and 6 drops of a 0.10% alcoholic solution of methyl red are added. This solution is then titrated with approximately 0.1 molar (M) HCl until the indicator turns pink. The end point occurs before complete coagulation takes place and the color change of the indicator can be detected against the white background of the slightly coagulated latex.

Total alkalinity may be calculated in various embodiments of the method. In one embodiment, total alkalinity is calculated in terms of NH₃ based on grams of NH₃ per 100 grams of latex, as follows: Total alkalinity (as NH₃)%=(1.7×M^{x} n)/W where: M=mole of the standard HCl; n=volume of standard HCl required, cm³, and; W=original mass of the latex. In another embodiment, total alkalinity is calculated as KOH, according to the following formula: Total alkalinity (as KOH) %=(5.61×M×n)/W where: M=mole of the standard HCl, n=volume of standard HCl required, cm³, and W=original mass of the latex. In yet another embodiment, total alkalinity is calculated based on the water phase of the latex, using the following calculation: Total alkalinity, as % of water=(1.7×M^{x} n)/W(1−TS/100) where: TS=percent total solids; M=mole of the standard HCl; n=volume of standard HCl required, cm³, and; W=original mass of the latex. In one additional embodiment, total alkalinity may be calculated as KOH based on the water phase of the latex, using the following formula: Total alkalinity, (as KOH) as % of water=(5.61×M×n)/W(1−TS/100) (6) where: TS=percent total solids; M=mole of the standard HCl; n=volume of standard HCl required, cm³ and; W=original mass of the latex.

### EXAMPLE 9

### Method for Measuring Viscosity in a Non-Hevea Latex Product

Samples are measured for viscosity using a Brookfield Viscometer, Model LVF or LVT (Brookfield Engineering, Inc., Stoughton, Mass.). The apparatus consists of a synchronous induction-type motor capable of driving at constant rotational speeds of 0.63 and 6.3 rad/s (6 and 60 rpm) a shaft to which spindles of different shapes and dimensions may be attached, a gear train to control speed of rotation of the spindles and a beryllium copper spring. The spindle, when rotating, is driven through the beryllium copper spring which winds up when a drag is exerted on it. The amount of drag is indicated by a pointer on the viscometer dial. This reading is proportional to the viscosity for any given speed and spindle. The Viscometer is calibrated by using fresh calibration oil (National Bureau of Standards) or silicone oil at ±0.02° C.

To measure viscosity, the sample is first strained through a standard 180-nm sieve with 0.180±0.009-mm (0.0070±0.0004-in.) openings and 0.131±0.01-mm (0.0052±0.0005-in.) wire diameter in order to adjust the latex to 60±0.1% total solids. The specimen is then conditioned to the desired test temperature of 25±2° C. in a water bath for a period of 2 hours in order to eliminate air from the latex.

The latex specimen is then slowly poured down the side of a 600-cm³ beaker, (cooled to 25° C.), in order to prevent air incorporation. In one embodiment, the spindle of the Viscometer is then immersed in the sample until the surface of the latex is within the notch in the shaft of the spindle. Alternatively, the spindle is immersed in the latex in the above manner before attaching it to the Viscometer. The Viscometer provides a reading on the 100 scale at 0.63 and 6.3 rad/s (6 and 60 rpm) using spindle No. 1. If the viscosity is greater than the limit of spindle No. 1, spindle No. 2 may be substituted.

In order to calculate viscosity, the reading is multiplied according to the following values, depending on the speed and spindle used: No. 1 spindle, 0.63 rad/s (6 rpm)=10; No. 1 spindle, 6.3 rad/s (60 rpm)=1; No. 2 spindle, 0.63 rad/s (6 rpm )=50; No. 2 spindle, 6.3 rad/s (60 rpm)=5. Viscosity is then recorded in millipascals per second (mPa/s) equivalent to centipoises.

### EXAMPLE 10

### Method for Measuring Sludge Content in a Non-Hevea Latex Product

To measure sludge content, 45 to 50 grams of guayule latex is measured into each of two 50-cm³ centrifuge tubes and centrifuged for 20 minutes at approximately 240 rad/s (2,300 rpm). Each tube is secured by a cap or film to prevent evaporation of latex or surface film formation. Any resulting surface creaming is scooped off and discarded, and supernatant latex is drawn off with a 2 mm pipette tip, until approximately 10 mm above the top of the sludge remains. The tubes are then filled to the top with an ammonia-alcohol solution (comprised of 28 cm³ ammonium hydroxide, 946 cm³ ethyl alcohol, 95% min purity, and 2,810 cm³ water) and re-centrifuged for about 25 minutes, and the process is repeated until the supernatant solution is clear. After the final centrifuging, the tubes are drained to the 1-cm mark and remaining residue is transferred to tared 200-cm³ beakers, using some of the ammonia-alcohol mixture as needed. The residue is then evaporated on a hot plate, dried at 70±2° C., and weighed. The masses of the dried residues run in duplicate should agree within I mg.

### EXAMPLE 11

### Method for Measuring Coagulum Content in a Non-Hevea Latex Product

To calculate coagulum content as a wt %, 200 grams of well-stirred guayule latex sample is diluted with an equal volume of 5% alkali soap solution and filtered through a 180-nm mesh screen sieve with 180±0.009-mm (0.0070±0.0004-in.) openings and 0.131±0.01-mm (0.0052±0.0005-in.) wire diameter. After passing through the screen, the screen is washed with a 5% soap solution followed by a wash with distilled water. The screen is then dried at 100±2° C. for 30 minutes, cooled in a desiccator, and weighed. The drying, cooling, and weighing procedure is repeated for intervals of 15 minutes until the loss in mass between successive weighings is less than 1 mg. The difference between the original mass of the screen and the mass of the screen plus coagulum retained on it represents the mass of dried coagulum. Coagulum content percentage is calculated as follows: Coagulum content, %=(mi/m₀)×100 where: mo=mass of test portion; and mi=mass of coagulum.

### EXAMPLE 12

### Method for Measuring KOH number in a Non-Hevea Latex Product

KOH number is calculated using a pH meter dependent on electrometric measurements and a glass electrode-flowing calomel assembly for determining a pH range from 8 to 14. A 50 gram guayule latex sample is first weighed into a 400-cm3 beaker, and ammonia content is adjusted to 0.5% on the water basis by addition of 5% formaldehyde (1 cm³=0.0189 g NH3) while stirring. (Formaldehyde solution (5%), cm³=W (100−TS) (% NH3 on water phase−0.50)/189 where: W=grams of wet latex sample g, and TS=percentage of total solids. Formaldehyde is prepared using dilute stock USP grade formaldehyde to 5.0% with distilled water and neutralized with 0.1 mol potassium hydrate (KOH) solution using phenolphthalein as an indicator and titrated to faint pink color).

Enough distilled water is added to dilute the latex to about 30% solids, and the titration electrodes are inserted into the latex sample to determine the pH. 5 cm³ of 0.5 mol KOH solution is then added while stirring, and the pH is again recorded after 10 seconds. Additions of 1-cm³ increments of 0.5 KOH solution are added while stirring, pH is recorded every 10 seconds after each addition, until an end point determination is made.

End point determination of the titration is made at the point where the curve of pH value forms an inflection in comparison to the volume in cm³ of KOH solution. At this point, the slope of the curve, the first differential, reaches a maximum and the second differential is zero. The end point is calculated from the second differential on the assumption that this is linear through the 1-cm³ increment through which it passes from positive to negative. Table 7 illustrates an example of the point of inflection determination. In Table 7, readings are shown only in the area approaching the inflexion. Points from 6.0 to 12.0 cm³ would have been taken but are not pertinent to the end point. As shown in Table 7, the slope of the line from +0.07 to −0.04 the intercept with zero gives a ratio of 7/11 of the distance between 15.0 and 16.0 cm³ of KOH. The point of inflection is, therefore, 15, 7/11, or 15.64. Proof of the ratio can be done by the geometry of the triangles formed.

TABLE 7

| | | First Difference | Second Difference |
|---|---|---|---|
| KOH Solution, cm³ | pH | ΔpH/Δcm³ | Δ (ΔpH/Δcm³) |
| 13.0 | 10.47 | | |
| 13.5 | . . . | 0.18 | . . . |
| 14.0 | 10.65 | . . . | 0.03 |
| 14.5 | . . . | 0.21 | . . . |
| 15.0 | 10.86 | . . . | 0.07 |
| 15.5 | . . . | 0.28 | . . . |
| 16.0 | 11.14 | . . . | −0.04 |
| 16.5 | . . . | 0.24 | . . . |
| 17.0 | 11.38 | . . . | −0.09 |
| 17.5 | . . . | 0.15 | . . . |
| 18.0 | 11.53 | . . . | |

KOH number, expressed as the number of grams of KOH required to neutralize the acids present in 100 grams of solids in latex, is calculated as follows: KOH No.=(cm³ KOH×M^{x} 561)/(TS×mass of sample) where: TS=percentage of total solids, and M=mole of standard KOH solution.

### EXAMPLE 13

### Method for Measuring pH number in a Non-Hevea Latex Product

pH is calculated using a standard meter dependent on electronic measurements and a glass electrode-calomel assembly for determining pH applicable for a pH range from 8 to 14. In one embodiment, the pH meter is calibrated in accordance with Method E 70 and the directions given by the manufacturer of the meter. In this embodiment, the temperature range of the latex sample is adjusted to 23±1° C. by mildly agitating the sample-container in a water bath at a suitable temperature. pH is then determined and recorded.

### EXAMPLE 14

### Method for Measuring Mechanical Stability in a Non-Hevea Latex Product

Mechanical stability of concentrated guayule latex is performed using a high-speed stirring technique consisting of a stirrer, an agitator, and a test bottle. In one embodiment, the stirring apparatus is a vertical shaft high-speed stirrer capable of maintaining a speed of 1470±22 rad/s (14 000±200 rpm) for the duration of the test. The stirrer shaft is approximately 6.3 mm (0.25 in.) in diameter at its lower end at the point of attachment of the agitator disk and may taper upward for greater strength, and it extends to the bottom of the test bottle, while maintaining relatively constant speed within 0.25 mm (0.010 in.) out of true at the specified speed.

In one embodiment, the agitator is a polished stainless steel disk 20.83±0.03 mm (0.820±0.001 in.) in diameter and 1.57±0.05 mm (0.062±0.902 in.) in thickness, with a threaded stud at its exact center for attachment to the center of the lower end of the stirrer shaft. In one embodiment, the test bottle is a flat-bottom, cylindrical glass container 57.8±1 mm (2.28±0.04 in.) in inside diameter by approximately 127 mm (5 in.) in height, with a wall thickness of approximately 2.3 mm (0.09 in.). In this embodiment, the bottle is capable of being lowered and raised to the exact specified position with relation to the shaft and agitator.

Prior to measuring the mechanical stability, the latex is stored at room temperature and preferably measured within 24 hours of air exposure. In one embodiment, guayule latex is diluted to exactly 43.0±0.2% total solids with aqueous ammonia solution (0.6% NH₃) and warmed by gentle stirring to 36-37° C. The latex is then strained through a 180-mm stainless steel sieve with 0.180±0.009-mm (0.0070±0.0004-in.) openings and 0.131±0.013-mm (0.0052±0.0005-in.) wire diameters. Approximately 80.0±0.5 grams of strained latex is then weighed into the test bottle and brought to a temperature of 35±1° C.

In this embodiment, the latex is then stirred at 14,000±200 rpm until the end point is reached, as indicated by the following conditions: drop of the meniscus of the latex, loss of turbulence, or change in sound of the stirring action. In this embodiment, the end point is determined by frequently dipping a glass rod into the latex and drawing it once lightly over the palm of the user's hand. Small pieces of coagulated rubber in the film being deposited on the palm signals the end of the test. This end point is confirmed by the presence of an increased amount of coagulated rubber in a film deposited after 15 seconds of additional agitation or by straining the latex through the 180-nm stainless steel screen described above.

The mechanical stability value for guayule latex is expressed as the number of seconds elapsed from the start of the test to the end point. Accuracy is confirmed over multiple replicate tests, where all values are within 5%.

### EXAMPLE 15

### Method for Measuring Copper and Manganese in a Non-Hevea Latex Product

Copper and manganese levels in parts per million are determined in accordance with methods described in ASTM D1278 Standards.

### EXAMPLE 16

### Method for Measuring Density in a Non-Hevea Latex Product Density

Determinations are used to calculate the mass of a measured volume of latex in locations where it is not possible to weigh directly. For such purposes it is essential that the density be determined on a latex sample containing the same amount of air as the latex contained when the volume was measured. Before sampling, latex is allowed to stand for a minimum of 24 hours to ensure the dispersal of air bubbles. Two embodiments of the method to calculate density are described herein, including the direct “referee” method and the indirect method. In the first embodiment, the density and volume are measured at identical temperatures (or are corrected if temperatures are slightly different). In the second embodiment, density of the latex is measured at any temperature by weighing a known amount of latex and a known amount of distilled water in a flask of known volume. Based on this measurement and known expansive properties of the latex, the density can be extrapolated for other temperatures (e.g., ambient temperature when volume is measured).

In the direct “referee” embodiment, a first flask containing guayule latex is heated to a constant temperature using a water bath, and stirred. A second flask filled with distilled water is heated to a constant temperature in the same water bath. A 50-cm³ capacity density bottle with a ground-glass stopper perforated by a capillary and a ground-glass cap is weighed to the nearest 0.001 g and immersed up to its neck in the same water bath with the glass stopper in place but not the cap. All three containers are heated to a constant temperature for approximately 20 minutes. Guayule latex is then blown into the density bottle to fill it, removed from the bath, and covered with the glass cap immediately. The bottle is then dried and weighed to the nearest 0.001 gram. The density bottle is re-calibrated after latex is discarded, and the process is repeated with distilled water according to the procedure above. Multiple replications may be used to ensure accuracy in measurement.

The density of the latex is then calculated according to the following formula: D=(M_{L}×D_{w})/M_{w} where: D=density of the latex at the temperature of the constant-temperature bath, mg/cm³; M_{L}=mass of latex in the density, bottle, g; M_{w}=mass of water in the density bottle, g, and D_{w}=density of water at the bath temperature, mg/m³. Density is the mass divided by the volume at a stated temperature, and units are converted where appropriate. The density of latex is determined in units of megagrams per cubic meter.

In the second indirect density calculation embodiment, a volumetric flask is calibrated by weighing to the nearest 1 mg. The flask is filled with distilled water at room temperature and marked with a line to indicate the water line. The flask with the water is then weighed to the nearest 1 mg. For this temperature, t, the volume of the flask is calculated to the mark as follows: V=(Bₜ−A)/dₜ where: V=volume in cubic centimeters of the flask at laboratory temperature; t=temperature of the water in the flask; Bₜ=mass of the flask plus the water at temperature t; A=mass of the empty flask, and dₜ=density of the distilled water in mg/cm³ at temperature t. Table 8 illustrates sample calculations at 25° C.

TABLE 8

| Property | Measurement | |
|---|---|---|
| Bt (25.0 C.) | 156.0018 | g |
| A | 52.997 | g |
| Mass of water (25.0 C.) | 103.004 | g |
| Density of water (25.0 C.) | 0.99707 | Mg/m3 |

| | |
|---|---|
| V = 103.004/0.99707 = | V is the volume of the flask to the |
| 103.307 cm3 | calibrated mark; at room temperature |

In this embodiment, density is calculated first weighing the clean, dry, calibrated flask to the nearest 1 mg. Guayule latex is then introduced into the flask until the flask is approximately half-filled, and then stoppered and re-weighed to the nearest 1 mg. The stopper is then removed and distilled water is added to the calibrated mark. During the addition of this water the flask is swirled periodically to release trapped air bubbles in the latex. After the liquid level reaches the mark, the flask is stoppered and weighed again to the nearest 1 mg.

After mixing the contents well, temperature is measured, and density is calculated using the following formula: Dₜ=(B−A)/[V−(C−B)/dₜ], where Dₜ=density of the latex in mg/cm³ at temperature t; t=temperature of the latex and water mixture in the volumetric flask; B=mass of the flask plus the latex; A=mass of the empty flask; V=volume of the flask to the calibrated mark on the stem; C=mass of the flask, latex, and water to the calibrated mark on the stem, and dₜ=density of tie distilled water in grams per cubic centimeter at temperature t. Table 9 illustrates a sample density calculation.

TABLE 9

| Property | Measurement | |
|---|---|---|
| B | 101.426 | g |
| A | 52.997 | g |
| Mass of latex | 48.429 | g |
| C | 153.187 | g |
| B | 101.426 | g |
| Mass of water | 51.761 | g |
| Temperature of mixture | 23.3° | C. |
| Density of water (23.3° C.) | 0.99749 | Mg/m³ |
| Volume of water (23.3° C.) | 51.761/0.99749 = 51.1/91 cm³ | |
| Volume of flask | 103.307 | cm³ |
| Volume of water (23.3° C.) | 51.891 | cm³ |
| Volume of latex (23.3° C.) | 51.416 | cm³ |
| Calculated Density of latex | D23.3 = 48.429/51.416 = 0.9419 Mg/m³ | |
| (23.3° C.) | | |
| Volume expansivity of latex | 0.00055 | Mg/m³ |
| (23.3° C.) | | |

| | |
|---|---|
| Calculation | 25.0 − 23.3 = 1.7-C. change |
| Calculation | 1.7 × 0.00055 = 0.0009 Mg/m³ |
| Final Calculation | D26 = 0.9419 − 0.0009 = 0.9410 Mg/m³ |

### EXAMPLE 17

### Method for Measuring Volatile Fatty Acids in a Non-Hevea Latex Product Volatile

Fatty acid number, or the number of grams of potassium hydroxide (KOH) required to neutralize the volatile fatty acid in a latex sample containing 100 grams of total solids is measured using a micro still procedure. In one embodiment, a Markham Semi-Micro Still or Modified Markham Semi-Micro Still (Ace Glass, Inc., Vineland, N.J.), a micro buret (e.g., a 10- cm³ micro buret) and a steam generator (e.g., consisting of a 2 to 3-cm³ flask, a hot plate with a temperature control, and suitable glass and rubber-tube connections with carborundum crystals or similar material shall be used to prevent bumping) are used to measure volatile fatty acids in guayule latex.

In one embodiment, 50±0.2 grams of concentrated latex is weighed in a 250-cm³ beaker and 50 cm³ of (NH₄)₂SO₄ solution is added, while stirring with a glass rod. The beaker is immersed in a 70° C. water bath for 3 to 5 minutes to coagulate the latex. The latex is then filtered to remove serum through a low-ash, medium-texture dry filter paper into a 50-cm³ Erlenmeyer flask. The coagulum is squeezed in the beaker with a glass rod to remove the remainder of the serum. 25 cm³ of the filtered serum is pipetted into a second 50-cm³ flask, along with 5 cm³ of H₂SO₄ (2+5), stoppered and swirled to mix. The still is purged by passing steam through it for a period of 15 minutes or longer before starting a series of tests. The inner chamber is emptied by siphon action by venting the steam generator, and then shutting off the steam supply to the still and opening the bottom drain. The discharge of water from the bottom drain creates negative pressure to empty the inner chamber, and the chamber is then flushed with distilled water.

To start distillation, the steam supply to the still is vented, and 10 cm³ of acidified serum is pipetted, along with a drop of silicone antifoam agent, into the inner chamber. A 100- cm³ graduated cylinder is placed under the condenser to collect the distillate and the steam is directed through the sample in the inner chamber. Steam flow is adjusted to produce distillate at a rate of 3 to 6 cm/min. 100 cm³ of the distillate is collected and aerated with air free of CO₂. A drop of bromothymol blue indicator is added and then the sample is titrated rapidly with 0.01 mol Ba(OH)₂ solution to a blue color that persists for about 10 to 20 seconds before turning green.

The volatile fatty acid number is calculated as follows: Volatile fatty acid number=(AM×561)/W×TS) where: A=cubic centimeters of Ba(OH)₂ solution required for titration of the sample, M=mole of the Ba(OH)₂ solution, W=mass of latex corresponding to 10 cm³ of acidified serum, and TS=percentage of total solids in the latex. W factor is calculated as follows: W(50×25)/[(50+S)×3] where: 50=gram of latex weighed out, 25=cubic centimeters of serum used, 50+S=cubic centimeters of (NH₄)₂SO₄ solution plus the cubic centimeters of serum in 50 grams of latex, and 3=ratio 30/10, where 30 is equal to 25 cm³ of filtered serum plus 5 cm³ of H₂SO₄, and 10 is equal to the 10-cm³ aliquot. The value of W is dependent on the total solids and the dry rubber content of the latex, but it need be recalculated only for significant differences in these values. Table 10 illustrates several typical values of W. The volume of serum, S, is calculated as follows: S=(100−DRC)/(1.02×2) where: DRC=percentage of dry rubber content of the latex, and 1.02 is the specific gravity of the serum.

TABLE 10

| | TS | DRC | W |
|---|---|---|---|
| Centrifuged latex | 62.5 | 61.0 | 6.03 |
| Creamed latex | 68.0 | 66.5 | 6.28 |
| Normal latex | 40.0 | 36.0 | 5.12 |

### EXAMPLE 18

### Method for Measuring Boric Acid in a Non-Hevea Latex Product Lattices That Contain a Boric Acid Preservative Agent

To measure boric acid content in guayule latex, a quantity of latex containing approximately 0.02 g boric acid is adjusted to pH 7.5 at which boric acid exists substantially in the undissociated form. Mannitol is then added in excess to form the strongly acidic boric acid-mannitol complex. Hydrogen ions equivalent to the boric acid present in the latex are thus liberated and the pH falls. Boric acid is determined from the amount of alkali required to restore the pH of the latex to its original value. The percentage (mass basis) of boric acid in the latex is calculated as follows: Boric acid (H₃O₃)=6.18×M×V/M where: M=mole of the NaOH solution, V=volume of NaOH solution required to restore the pH of the latex to 7.50 cm³, and M=mass of the latex specimen in grams.

### EXAMPLE 19

### Method for Measuring Precision and Bias In Testing a Non-Hevea Latex Product

The precision of each test method is estimated from an inter-laboratory study of three different natural rubber lattices from Hevea brasiliensis and then extrapolated for guayule latex. Guayule latex testing reporting will include additional precision and bias information where available.

### EXAMPLE 20

### Results of Guayule Standard Testing for Non-Hevea Latex

Tests are performed in accordance with the procedures described in ASTM D1076-02 Standard specification values for commercially available Type 1 and Type 2 Hevea latex Tests are also performed in accordance with the methods disclosed herein for guayule latex for Total Solids Content (%); Dry Rubber Content (%); Total Alkalinity, KOH as % Latex; Viscosity; Sludge Content; Coagulum Content; KOH number; pH; Mechanical Stability; Copper (ppm) and Manganese (ppm); Density (Mg/m³); Protein Content, and Volatile Fatty Acids according to the methods disclosed above. Tables 11 and 12 show actual specific data for Guayule latex samples tested according to the disclosed method. In Table 11, the guayule latex sample tested was processed by centrifugation and creaming. However, Table 12 illustrates experimental results for guayule latex samples that were (1) centrifuged only and (2) centrifuged and creamed. Table 12 also shows the results for each that were (1) KOH-buffered and (2) ammoniated.

As shown in Table 11, guayule latex demonstrates comparable results to Type 1 and Type 2 Hevea latex for Total Solids Content (%); Dry Rubber Content (%); Total Alkalinity, KOH as % Latex; Viscosity; Sludge Content; Coagulum Content; KOH number; pH; Mechanical Stability; Copper and Manganese; Density (mg/m³) Color and Odor. As shown in Table 12, guayule latex with various buffer and ammonia compositions also demonstrates results comparable to Type 1 and Type 2 Hevea latex.

TABLE 11

| | Hevea | Hevea | Guayule |
|---|---|---|---|
| | ASTM Spec | ASTM Spec | Centrifuged |
| | D1076-02, Type 1 | D1076-02, Type 2 | and Creamed |
| | Centrifuged NRL | Creamed NRL | (Ammoniated) |
| Total Solids Content | 61.3% min | 66.0% min | 50.0 |
| (%) | | | |
| Dry Rubber Content | 59.8% min | 64.0% min | 48.8 |
| (%) | | | |
| Total Alkalinity, | 0.6% min as NH3 | 0.55% min as NH3 | 0.14 |
| KOH as % Latex | | | |
| Viscosity @ 43% | No requirement | No requirement | 27.7 |
| TSC, cps | | | |
| Sludge, weight % | 0.10% max | 0.10% max | 0.004 |
| Coagulum, weight % | 0.05% max | 0.05% max | 0.002 |
| KOH number | 0.80 max | 0.80 max | ND |
| pH | No requirement | No requirement | 11.5 |
| Mechanical Stability | 650 min @ 55% | 650 min @ 55% | 149 sec. @ 43% |
| | TSC | TSC | TSC |
| Copper (ppm) | 8 ppm max (dw | 8 ppm max (dw | 4.3 |
| | rubber) | rubber) | |
| Manganese (ppm) | 8 ppm max (dw | 8 ppm max (dw | 0.7 |
| | rubber) | rubber) | |
| Magnesium (ppm) | No requirement | No requirement | 24 |
| Density (Mg/m3) | No requirement | No requirement | 0.95 |
| Color | No pronounced blue | No pronounced blue | Off-white |
| | or grey | or grey | |
| Odor | No putrifactive odor | No putrifactive odor | Ammonia |

TABLE 12

| | Guayule KOH- | Guayule KOH- | Guayule | Guayule |
|---|---|---|---|---|
| ASTM D1076-02 | Buffered | Buffered | Ammoniated | Ammoniated |
| Properties | Latex Product | Latex Product | Latex Product | Latex Product |
| Final Processing Step | Centrifuged | Centrifuged | Centrifuged | Centrifuged |
| | | and Creamed | | and Creamed |
| Total Solids Content | 48.0 | 54.0 | 48.0 | 54.0 |
| (%) | | | | |
| Dry Rubber Content | 47.0 | 53.0 | 47.0 | 53.0 |
| (%) | | | | |
| Total Alkalinity, | 0.10 | 0.40 | 0.10 | 0.40 |
| KOH as % Latex | | | | |
| Viscosity @ 43% | 20.0 | 150.0 | 20.0 | 150.0 |
| TSC, cps | | | | |
| Sludge, weight % | — | 0.07 | — | 0.07 |
| Coagulum, weight % | — | 0.02 | — | 0.02 |
| pH | 11.0 | 13.0 | 11.0 | 13.0 |
| Mechanical Stability @ | 100.0 | 600.0 | 100.0 | 600.0 |
| 43% TSC, seconds | | | | |
| Copper (ppm) | — | 6.0 | — | 6.0 |
| Manganese (ppm) | — | 6.0 | — | 6.0 |
| Density (Mg/m3) | 0.940 | 0.960 | 0.940 | 0.960 |
| Color | Off-white, | Off-white, | Off-white, | Off-white, |
| | beige | beige | beige | beige |
| Odor | No Odor | No Odor | Mild smell | Mild smell |
| | | | of ammonia | of ammonia |

### EXAMPLE 21

### Results of ELISA Assay D6499 and Modified Lowry Assay D5712 Testing for Non-Hevea Latex

Samples of latex gloves made from guayule latex are weighed and measured, and cut to allow buffer contact with all surfaces. Extraction is performed for 2 hours with constant agitation at 25°±5° C. in 100 mM phosphate buffered saline at a pH of 7.4 (PBS) at an extraction ratio of 5:1 (ml buffer/gram sample). The latex extract is centrifuged to remove particulates and then assayed using ELISA inhibition assays using ASTM D6499 Standard protocols, Modified Lowry Assays using ASTM D5712 Standard protocols, and background subtraction techniques using ASTM D5712 Standard protocols.

For the ELISA Inhibition assay, the sample is assayed using seven 2-fold dilution series in duplicate series, and then run according to standard ASTM D6499 protocols. The resulting data are calculated by using latex protein extracted from non-compounded ammoniated latex as a reference, and the data are expressed as antigenic latex protein in micrograms/gram of sample and micrograms/dm².

For the Modified Lowry Assay, three extracts are precipitated with deoxycholate/tricholoacetic acid/phosphotungstic acid, re-suspended in NaOH and then tested using standard ASTM D5712 protocols. The samples are assayed using four 2-fold serial dilutions in duplicate, and the results are calculated using ovalbumin as the reference standard against the resulting data, expressed in micrograms protein/dm², as shown in Table 13.

TABLE 13

| | | | | | Total Protein | Total Protein |
|---|---|---|---|---|---|---|
| | | Extract | Lowry Assay | | Concentration | Concentration |
| | Sample | Volume | Concentration | Surface | (μg/gm) | (μg/gm) |
| Replicate | Weight | (ml PBS) | (μg/ml) | Area | Mean | Mean |
| Trial 1 | 12.2 | 61 | 8 | 11.9 | <41 | <41 |
| Trial 2 | 12.5 | 63 | Below | 11.9 | <41 | <41 |
| | | | detection | | | |
| Trial 3 | 10.9 | 55 | Below | 11.7 | <41 | <41 |
| | | | detection | | | |

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive nor limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A latex product, comprising:
elastomeric material comprising rubber derived from a non-Hevea plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and substantial impermeability to water vapor and water liquid.

2. The latex product of claim 1, wherein the non-Hevea plant is guayule.

3. The latex product of claim 1, wherein the Hevea antigenic protein is selected from a group consisting of: Hev b1, Hev b3, Hev b2, Hev b4, Hev b6.01, Hev b6.02, Hev b6.03, Hev b7.01, Hev b7.02, Hev b11, Hev b12, Hev b5, Hev b8, Hev b9, and Hev b10.

4. The latex product of claim 1, further including having the characteristic of no detectable amount of any Hevea antigenic proteins as measured according to ASTM D6499.

5. The latex product of claim 4, wherein the Hevea antigenic proteins include Hev b1, Hev b3, Hev b2, Hev b4, Hev 6.01, Hev b6.02, Hev b6.03, Hev b7.01, Hev b7.02, Hev b11, Hev b12, Hev b5, Hev b8, Hev b9, and Hev b10.

6. The latex product of claim 1, the elastomeric material further including having the characteristic of a total alkalinity equal to or greater than approximately one tenth of one percent.

7. The latex product of claim 1, the elastomeric material further including having the characteristic of no detectable odor.

8. The latex product of claim 1, further including having the characteristic of a hydrophobic protein to hydrophilic protein ratio equal to or greater than approximately nine to one.

9. The latex product of claim 1, further including at least one layer of the elastomeric material.

10. The latex product of claim 9, wherein the layer of elastomeric material comprises a coating for a second latex product, wherein the second latex product is selected from a group consisting of: a Hevea latex product and a synthetic latex product.

11. The latex product of claim 10, wherein the non-Hevea, non-guayule latex product is derived from a rubber producing species, selected from the group consisting of: gopher plant; mariola; rabbitbrush; milkweeds; goldenrods; pale Indian plantain; Russian dandelion; mountain mint; American germander; Madagascan rubber vine; and tall bell flower.

12. The latex product of claim 9, the layer of elastomeric material further including having a configuration including four finger receptacles; a thumb receptacle; and being capable of covering a human hand.

13. The latex product of claim 1, wherein the elastomeric material forms a portion of a medical device.

14. The latex product of claim 13, wherein the medical device is selected from a group consisting of: a glove, a catheter, medical adhesive, a wound care-product, laboratory testing equipment, an assay, a disposable kit, a drug container, a syringe, a valve, a seal, a port, a plunger, forceps, a dropper, a stopper, a bandage, a wound dressing, an examination sheet, an endo-device sheath, a solution bag, a balloon, a thermometer, a spatula, tubing, a binding agent, a needle cover, a tourniquet, tape, a mask, a stethoscope, a compression band, straps, an inflation system, a brace, a splint, a cervical collar, and crutches.

15. A method of identifying a latex product with low allergenicity, comprising:
obtaining a sample from the latex product for identification;
detecting the presence or absence of a Hevea antigenic protein in the sample according to ASTM D6499;
measuring the total protein content in the sample according to ASTM D5712; and
determining that the sample has low allergencity when no Hevea antigenic protein is detected and the total protein count is less than or equal to approximately two hundred micrograms per gram of dry weight latex.

16. The method of claim 15, wherein the Hevea antigenic protein is selected from a group consisting of: Hev b1, Hev b3, Hev b2, Hev b4, Hev b6.01, Hev b6.02, Hev b6.03, Hev b7.01, Hev b7.02, Hev b11, Hev b12, Hev b5, Hev b8, Hev b9, and Hev b10.

17. The method of claim 15, further including detecting the presence or absence of a set of Hevea antigenic proteins as measured according to ASTM D6499.

18. The method of claim 17, wherein the set of Hevea antigenic proteins includes two or more Hevea antigenic proteins selected from the group consisting of: Hev b1, Hev b3, Hev b2, Hev b4, Hev b6.01, Hev b6.02, Hev b6.03, Hev b7.01, Hev b7.02, Hev b11, Hev b12, Hev b5, Hev b8, Hev b9, and Hev b10.

19. The method of claim 15, further including measuring a hydrophobic protein to hydrophilic protein ratio of the sample; and determining that the sample has low allergencity when the hydrophobic protein to hydrophilic protein ratio is equal to or greater than approximately nine to one.

20. The method of claim 15, further including determining total alkalinity of the sample; and determining that the sample has low allergencity when the total alkalinity is greater than or equal to approximately one tenth of one percent.

21. The method of claim 15, further including detecting the presence or absence of odor emanating from the sample; determining that the sample has low allergencity when there is no detectable odor emanating from the sample.

22. A latex product, comprising:
a dry film comprising rubber derived from a guayule plant, the dry film having characteristics including no detectable amount of a Hevea antigenic protein as measured according to ASTM D6499; a total protein content of less than or equal to approximately two hundred micrograms per gram of dry weight latex as measured according to ASTM D5712; and substantial impermeability to water vapor and water liquid.

23. A glove, comprising:
elastomeric material having a configuration including four finger receptacles; a thumb receptacle; and being capable of covering a human hand; and wherein the elastomeric material comprises rubber derived from a guayule plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and impermeability to pathogenic human viruses.

24. A catheter, comprising:
elastomeric material comprising rubber derived from a guayule plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and substantial impermeability to water vapor and water liquid.

25. A device capable of preventing a mammal sperm from fertilizing a mammal egg, comprising:
a barrier comprising elastomeric material, the elastomeric material comprising rubber derived from a guayule plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and impermeability to sperm of a mammal.

26. The device of claim 25, wherein the barrier is selected from the group consisting of: a male condom, a female condom, a sponge, a cervical cap, and a diaphragm.

27. A dental dam, comprising:
elastomeric material comprising rubber derived from a guayule plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and substantial impermeability to water vapor and water liquid.

28. A condom, comprising:
a body having a wall, a closed end and an open end, the wall defining a protrusion including an interior surface and an exterior surface, wherein the body is comprised of an elastomeric material comprising rubber derived from a guayule plant, the elastomeric material having characteristics including no detectable amount of Hevea antigenic protein as measured according to ASTM D6499; a total protein content of less than or equal to approximately two hundred micrograms per gram of dry weight latex as measured according to ASTM D5712; and impermeability to pathogenic human viruses.
